(19) United States
(12) Patent Application Publication
(10) Pub. No.: US 2014/0009965 A1
(43) Pub. Date: Jan. 9, 2014

(54) LIGHTING DEVICE AND DISPLAY DEVICE

(71) Applicant: Kenji Takase, Osaka-shi (JP)

(72) Inventor: Kenji Takase, Osaka-shi (JP)

(73) Assignee: SHARP KABUSHIKI KAISHA, Osaka-shi, Osaka (JP)

(21) Appl. No.: 14/007,398

(22) PCT Filed: Apr. 6, 2012
(86) PCT No.: PCT/JP2012/059517

§ 371 Date: Sep. 25, 2013

(30) Foreign Application Priority Data
Apr. 13, 2011 (JP) 2011-088864

(51) Int. Cl. F21V 8/00

(52) U.S. Cl. CPC G02B 6/0068
USPC 362/613

(57) ABSTRACT

Provided is a lighting device that can reduce the number of light sources while assuring brightness at the center part of an illuminated member. This lighting device (10) is provided with a plurality of light sources (11) and a light guide plate (13) that has light from the light sources incident thereto and guides the light from the light sources. The plurality of light sources are disposed along at least one side surface (13b) of the light guide plate, and the density of disposition of the light sources in the center in the direction of disposition of the plurality of light sources is higher than the density of the disposition of the light sources at the end parts in the direction of the disposition of the plurality of light sources.

### TECHNICAL FIELD

This invention relates to a lighting device and a display device, and relates particularly to a lighting device including a plurality of light sources and a light guide plate that guides light from the light sources, and a display device.

### BACKGROUND ART

In a liquid crystal display device (display device) incorporating a non-luminous type display panel (member to be illuminated), typically, a backlight device (lighting device) that irradiates the display panel with light also is incorporated. As such a backlight device, there is known a backlight devie including a plurality of LEDs (light sources) and a light guide plate that guides light from the LEDs.

FIG. 20 is a view showing a structure of a backlight device according to one conventional example. As shown in FIG. 20, a backlight device 1001 according to the one conventional example includes a plurality of LEDs 1002, a mounting substrate 1003 on which the plurality of LEDs 1002 are mounted, and a light guide plate 1004 that guides light from the plurality of LEDs 1002. The light guide plate 1004 includes a light output surface 1004a that outputs light to the side of a display panel (not shown) and four (four-side) side surfaces 1004b. The plurality of LEDs 1002 are arrayed along one of the side surfaces 1004b of the light guide plate 1004 on the topside in the figure. Furthermore, the plurality of LEDs 1002 are arrayed at equal pitches.

A backlight device in which a plurality of light sources are arrayed along a side surface of a light guide plate is disclosed in, for example, Patent Document 1.

### LIST OF CITATIONS

### Patent Literature

Patent Document 1: JP-A-2011-34692

### SUMMARY OF THE INVENTION

### Technical Problem

The backlight device 1001 shown in FIG. 20, however, is disadvantageous in that, if the number of the LEDs 1002 is reduced for the purpose of a cost reduction, the brightness of the display panel is decreased, and accordingly, the brightness of the display panel at a center portion thereof is decreased. When the brightness of the display panel is higher at the center portion thereof than at end portions (peripheral portion) thereof, the brightness of the display panel as a whole looks high under a psychological or physiological illusion, and thus it is important to secure the brightness at the center portion.

This invention has been made to solve the above-described problem and has as its object to provide a lighting device that, while securing the brightness of a member to be illuminated at a center portion thereof, allows the number of light sources used to be reduced, and a display device.

### Solution to the Problem

In order to achieve the above-described object, a lighting device of this invention is a lighting device that is disposed on a rear surface side of a member to be illuminated and includes a plurality of light sources and a light guide plate that light from the light sources enters and that guides light from the light sources. In the lighting device, the plurality of light sources are arrayed along at least one side surface of the light guide plate, and a disposition density of the light sources is higher at a center portion in an array direction of the plurality of light sources than at end portions in the array direction of the plurality of light sources.

In this lighting device, as described above, the disposition density of the light sources is set to be higher at the center portion in the array direction of the plurality of light sources than at the end portions in the array direction of the plurality of light sources, and thus the brightness of the member to be illuminated becomes higher at a center portion thereof than at end portions thereof.

In the above-described lighting device, preferably, the disposition density of the light sources becomes higher in a direction from each of the end portions toward the center portion. This configuration can make the brightness of the member to be illuminated become gradually higher in a direction from each of end portions thereof toward a center portion thereof and thus can suppress the occurrence of unevenness in brightness of the member to be illuminated.

In the above-described lighting device, the plurality of light sources may be arrayed along at least one short-side side surface of the light guide plate.

In the above-described lighting device in which the plurality of light sources are arrayed along the short-side side surface(s) of the light guide plate, preferably, the plurality of light sources are arrayed along both short-side side surfaces of the light guide plate.

In the above-described lighting device in which the plurality of light sources are arrayed along both the short-side side surfaces of the light guide plate, preferably, the plurality of light sources are disposed symmetrically with respect to a center line of the light guide plate in a longer length direction thereof.

In the above-described lighting device, the plurality of light sources may be arrayed along at least one long-side side surface of the light guide plate.

In the above-described lighting device in which the plurality of light sources are arrayed along the long-side side surface(s) of the light guide plate, preferably, the plurality of light sources are arrayed along both long-side side surfaces of the light guide plate.

In the above-described lighting device in which the plurality of light sources are arrayed along both the long-side side surfaces of the light guide plate, preferably, the plurality of light sources are disposed symmetrically with respect to a center line of the light guide plate in a shorter length direction thereof.

In the above-described lighting device, preferably, power to be supplied to each one among the light sources at the end portions is larger than power to be supplied to each one among the light sources at the center portion.

In the above-described lighting device, a configuration may be adopted in which the plurality of light sources are arrayed along an upper-side side surface and a lower-side side surface of the light guide plate, and a number of those of the light sources that are arrayed along the lower-side side surface is smaller than a number of those of the light sources that are arrayed along the upper-side side surface.

In the above-described lighting device, preferably, the plurality of light sources are arrayed along an upper-side side surface and a lower-side side surface of the light guide plate, and power to be supplied to each of those of the light sources that are arrayed along the lower-side side surface is smaller than power to be supplied to each of those of the light sources that are arrayed along the upper-side side surface.

A display device of this invention includes the lighting device configured as above and a display panel that is illuminated by the lighting device.

### Advantageous Effects of the Invention

As described above, according to the present invention, a disposition density of a plurality of light sources is set to be higher at a center portion in an array direction of the light sources than at end portions in the array direction of the light sources, and thus the brightness of a member to be illuminated becomes higher at a center portion thereof than at end portions thereof. Thus, even in a case where the number of the light sources is reduced, the brightness of the member to be illuminated at the center portion thereof can be secured. Furthermore, since the number of the light sources can be reduced, weight and cost reductions of a lighting device can be achieved.

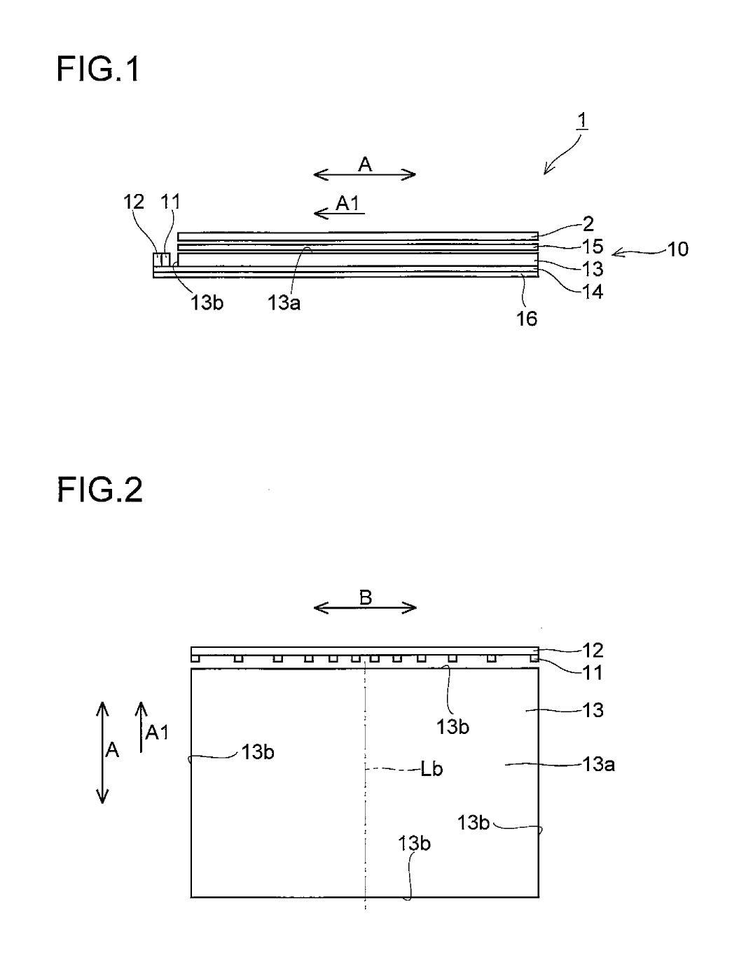

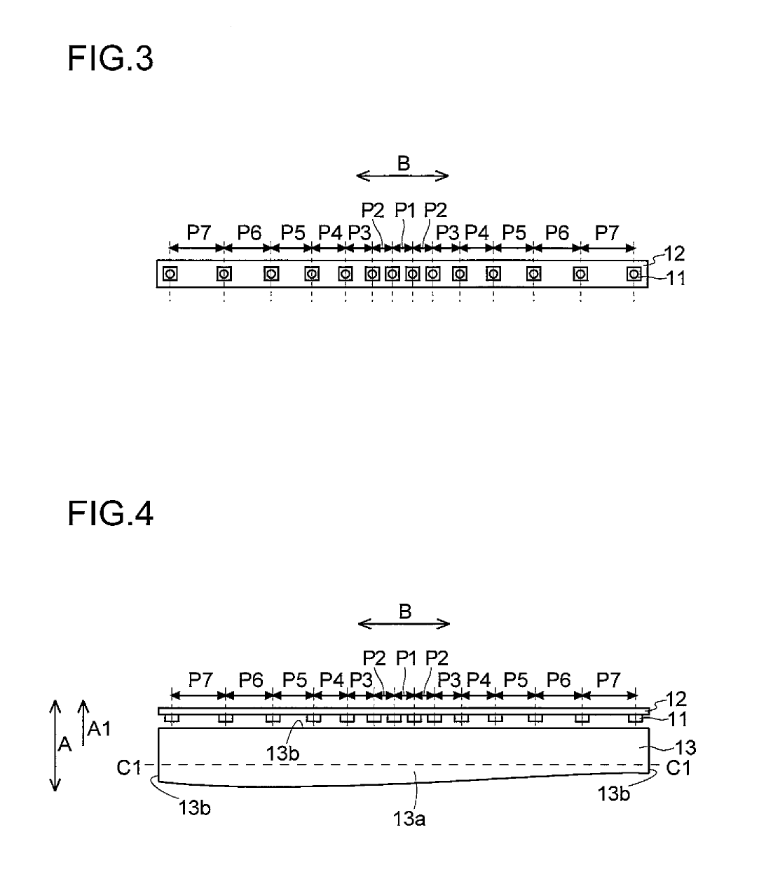

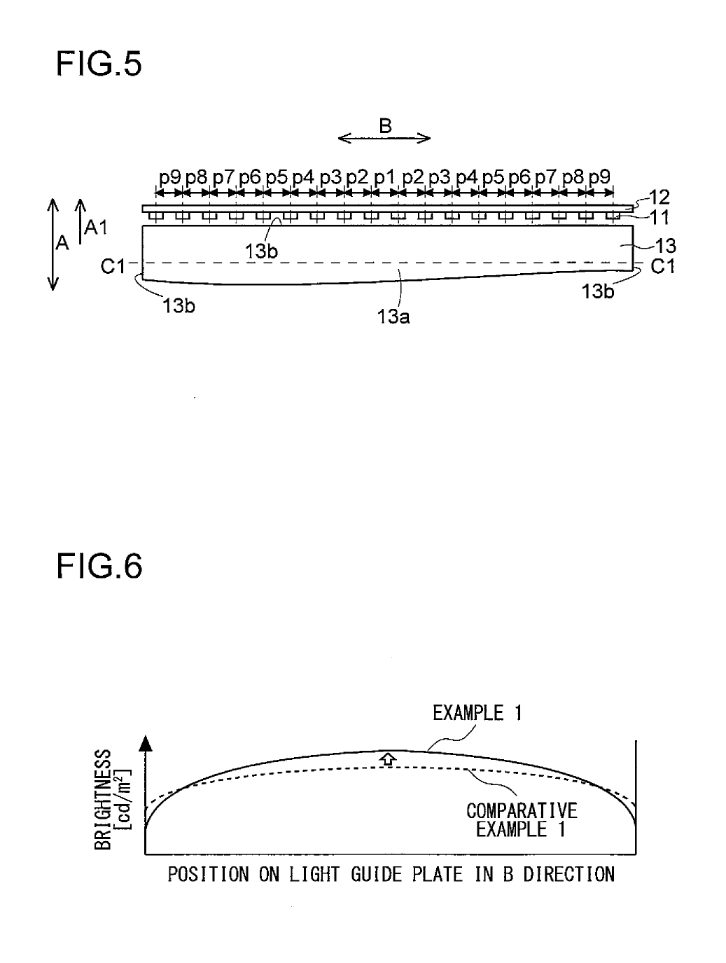

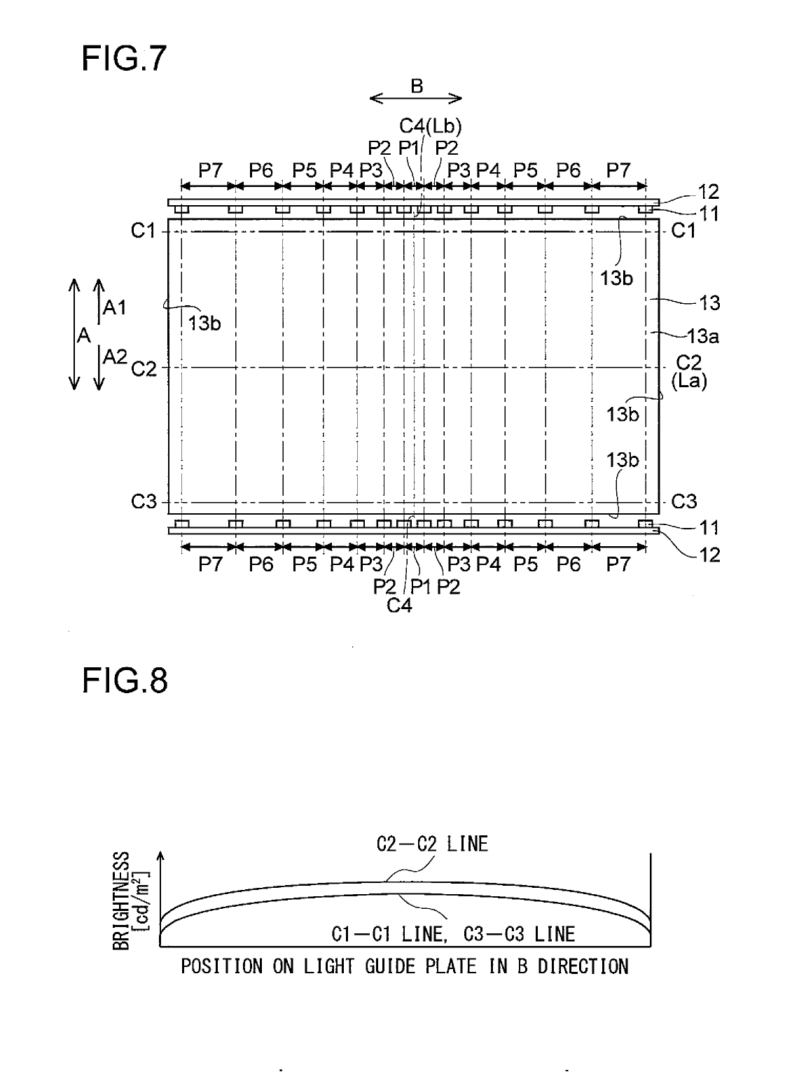

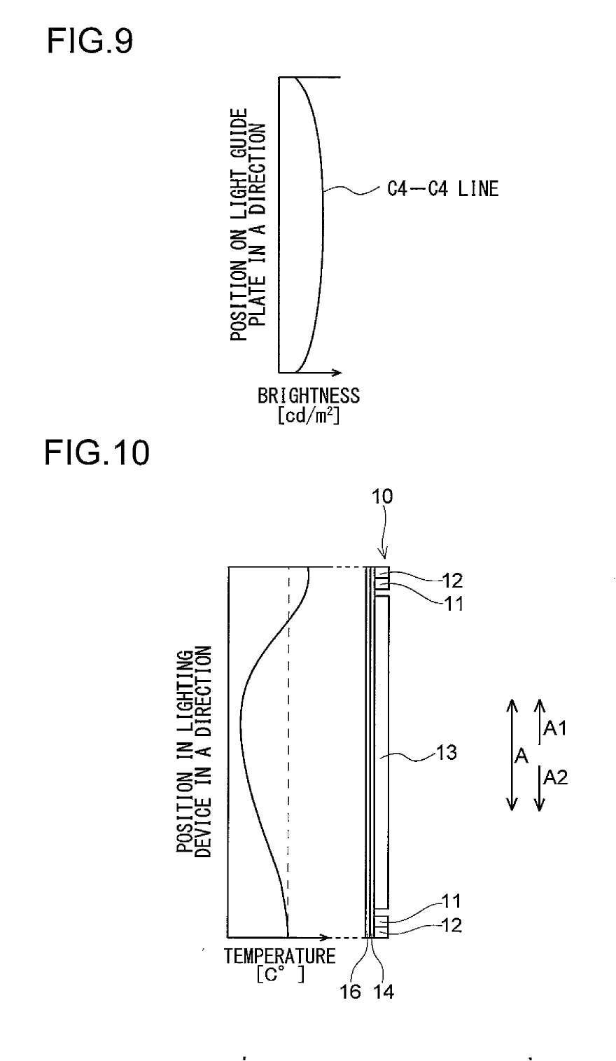

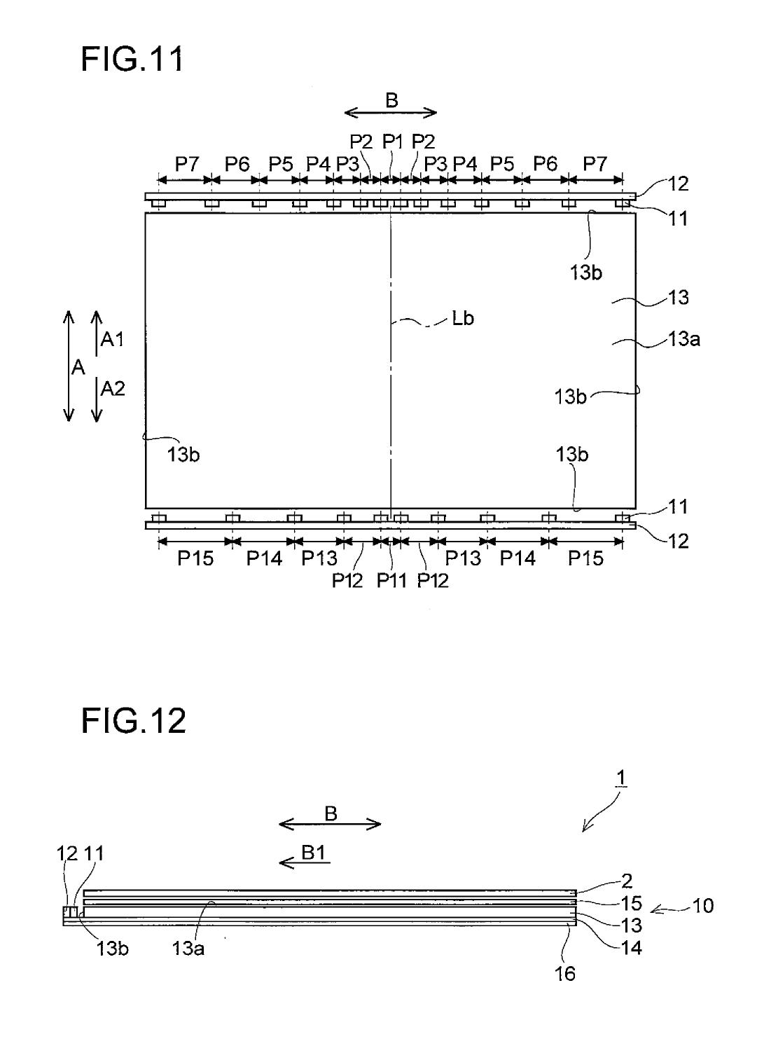

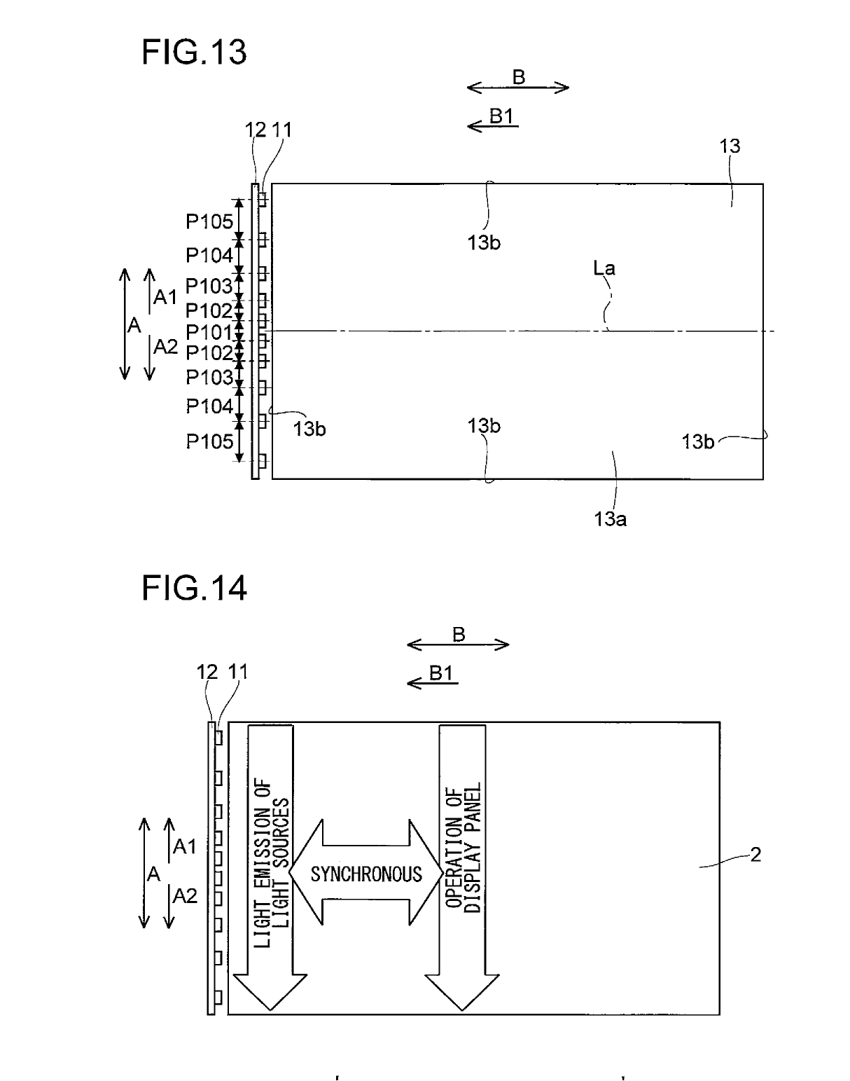

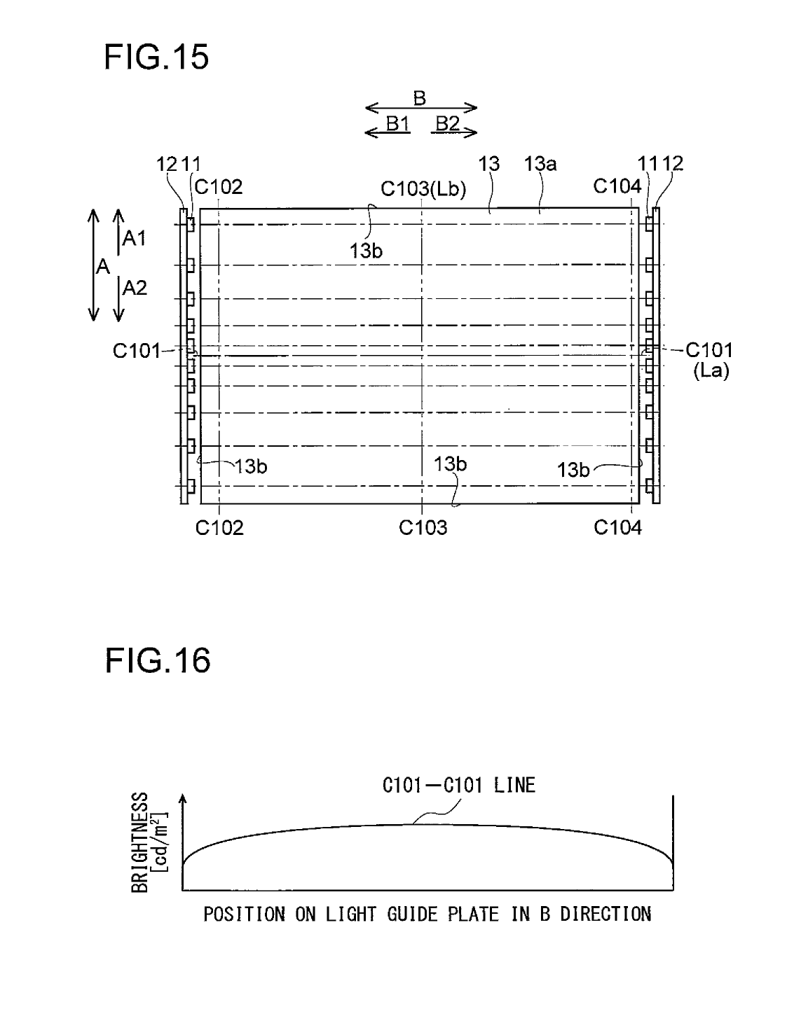

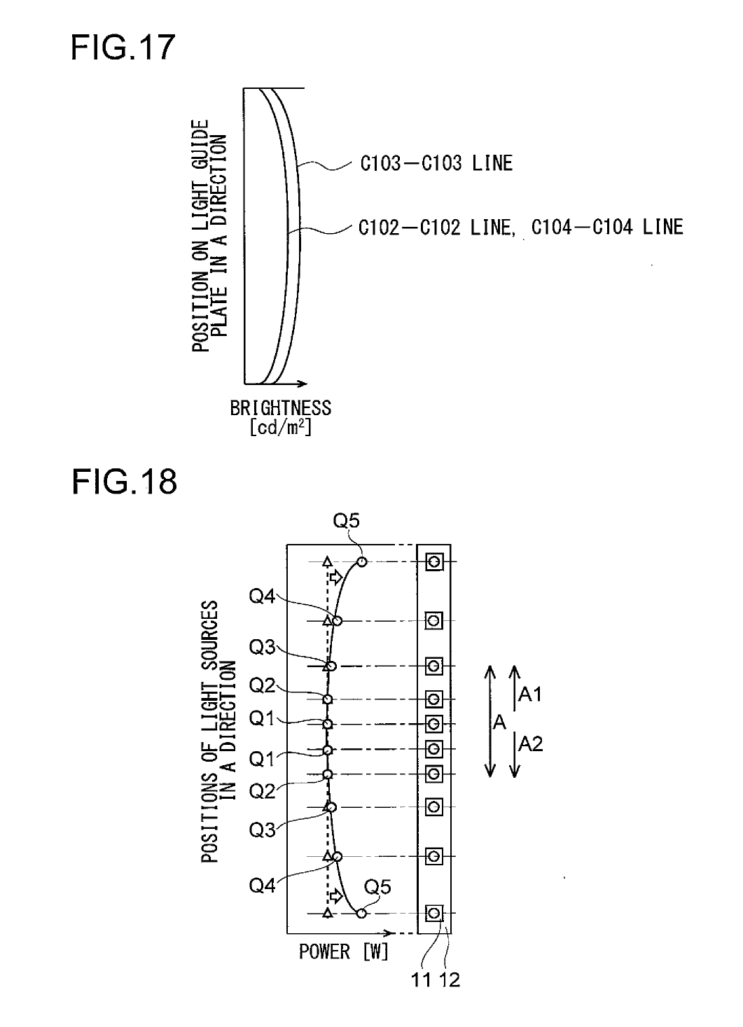

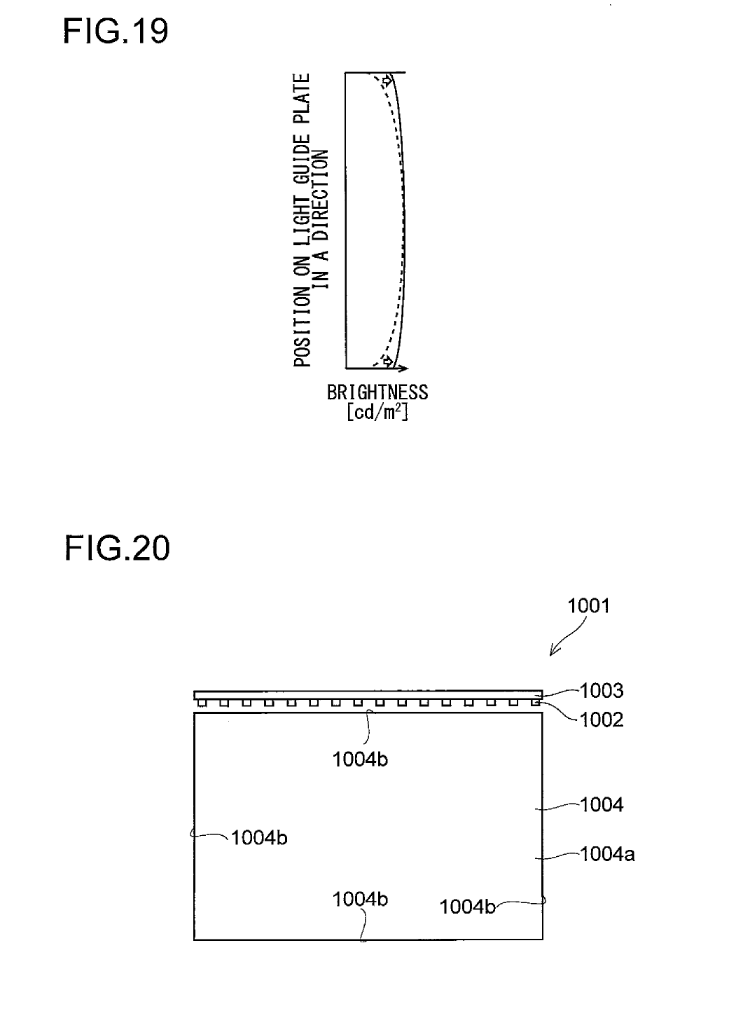

### BRIEF DESCRIPTION OF DRAWINGS

[FIG. 1] is a sectional view showing a structure of a display device according to a first embodiment of the present invention.

[FIG. 2] is a view showing structures of light sources and a light guide plate shown in FIG. 1 as seen from the side of a light output surface of the light guide plate.

[FIG. 3] is a view showing structures of the light sources and a mounting substrate shown in FIG. 1 as seen from the side of the light guide plate.

[FIG. 4] is a view showing a structure in the vicinity of light sources in Example 1 as seen from the side of a light output surface of a light guide plate.

[FIG. 5] is a view showing a structure in the vicinity of light sources in Comparative Example 1 as seen from the side of a light output surface of a light guide plate.

[FIG. 6] is a view showing brightness distributions on the light guide plates along C1-C1 lines in Example 1 and Comparative Example 1.

[FIG. 7] is a view showing structures of light sources and a light guide plate in a display device according to a second embodiment of the present invention as seen from the side of a light output surface of the light guide plate.

[FIG. 8] is a view showing brightness distributions on the light guide plate along C1-C1, C2-C2, and C3-C3 lines in FIG. 7. [FIG. 9] is a view showing a brightness distribution on the light guide plate along a C4-C4 line in FIG. 7.

[FIG. 10] is a view showing a temperature distribution in a lighting device in a case where the display device according to the second embodiment of the present invention is used in a vertically disposed state.

[FIG. 11] is a view showing structures of light sources and a light guide plate in a display device according to a third embodiment of the present invention as seen from the side of a light output surface of the light guide plate.

[FIG. 12] is a sectional view showing a structure of a display device according to a fourth embodiment of the present invention.

[FIG. 13] is a view showing structures of light sources and a light guide plate shown in FIG. 12 as seen from the side of a light output surface of the light guide plate.

[FIG. 14] is a view for explaining a relationship between an operation of a display panel shown in FIG. 12 and light emission of the light sources.

[FIG. 15] is a view showing structures of light sources and a light guide plate in a display device according to a fifth embodiment of the present invention as seen from the side of a light output surface of the light guide plate.

[FIG. 16] is a view showing a brightness distribution on the light guide plate along a C101-C101 line in FIG. 15.

[FIG. 17] is a view showing brightness distributions on the light guide plate along C102-C102, C103-C103, and C104-C104 lines in FIG. 15.

[FIG. 18] is a view for explaining power supplied to each of light sources in a display device according to a sixth embodiment of the present invention.

[FIG. 19] is a view showing a brightness distribution on a light guide plate in the display device according to the sixth embodiment of the present invention.

[FIG. 20] is a view showing a structure of a backlight device according to one conventional example.

### DESCRIPTION OF EMBODIMENTS

Hereinafter, embodiments of the present invention will be described with reference to the appended drawings. For the sake of easier understanding, sectional views may not be provided with hatching.

### First Embodiment

First, with reference to FIGS. 1 to 3, a description is given of a structure of a display device 1 according to a first embodiment of the present invention.

The display device 1 according to the first embodiment of the present invention constitutes, for example, a liquid crystal television receiver (not shown). Furthermore, as shown in FIG. 1, the display device 1 is composed of a display panel 2 (member to be illuminated) and a lighting device 10 that is disposed on the rear surface side of the display panel 2 and illuminates the display panel 2. It is to be noted that the “rear (bottom side in FIG. 1)” as in a rear surface of the display panel 2 is a concept of orientation applied also to other constituent components. Furthermore, the display device 1 can be vertically disposed (disposed such that the display panel 2 stands in a vertical direction) or non-vertically disposed. Herein, the non-vertical disposition, in its intended meaning, does not exclude the vertical disposition but refers to a case where a disposition direction of the display panel 2 is not constant such as when the display device 1 is incorporated in a portable device or the like or a case where the display panel 2 is disposed, for example, to lie in a horizontal direction. The following mainly describes a case where the display device 1 is non-vertically disposed and also describes, where necessary, a case where the display device 1 is vertically disposed.

The display panel 2 is constituted by a liquid crystal display panel and has two glass substrates that sandwich an unshown liquid crystal layer therebetween. Furthermore, the display panel 2 displays an image by being illuminated by the lighting device 10.

The lighting device 10 is a backlight device of an edge-light type (referred to also as a sidelight type) and includes a plurality of light sources 11, a mounting substrate 12 on which the plurality of light sources 11 are mounted, a light guide plate 13 that guides light from the plurality of light sources 11, a reflection sheet 14 that is disposed on the rear surface side of the light guide plate 13, an optical sheet 15 that is disposed on the side of a light output surface 13a of the light guide plate 13, and a backlight chassis 16 that is disposed on the rear surface side of these components.

The light guide plate 13 has a function of guiding light from the light sources 11 while totally reflecting the light and outputting the light to the side of the display panel 2. Furthermore, as shown in FIG. 2, the light guide plate 13 includes the light output surface 13a having a substantially rectangular shape and four (four-side) side surfaces 13b. In this embodiment, among the four side surfaces 13b, a side surface (side surface on an A1 side) 13b, which is one of long-side side surfaces 13b, acts as a light input surface. For the sake of easier explanation, a shorter length direction of the light guide plate 13 is denoted as an A direction, and one side in the shorter length direction is denoted as the A1 side. Furthermore, a longer length direction of the light guide plate 13 is denoted as a B direction.

Furthermore, at a rear surface of the light guide plate 13, a processed portion (such as a grain pattern, a dotted pattern, or a prism) is formed that changes a traveling direction of light that has entered from the side surface (light input surface) 13b on the A1 side, thereby to cause the light to be outputted from the light output surface 13a. Thus, light that has reached the processed portion is reflected or refracted by the processed portion and, therefore, no longer satisfies a total reflection condition, so that the light is outputted from the light output surface 13a to the side of the display panel 2. Examples of a material of the light guide plate 13 include resins having a light transmitting property, such as, for example, a polycarbonate resin and an acrylic resin.

As will be described later, the plurality of light sources 11 are disposed symmetrically with respect to a center line Lb of the light guide plate 13 in the B direction, and accordingly, the processed portion at the rear surface of the light guide plate 13 also is formed symmetrically with respect to the center line Lb of the light guide plate 13 in the B direction.

The plurality of light sources 11 are arrayed in the B direction (longer length direction of the light guide plate 13) along the side surface (light input surface) 13b on the A1 side of the light guide plate 13. Furthermore, the light sources 11 are configured to emit light toward the side surface (light input surface) 13b on the A1 side. Furthermore, the light sources 11 are constituted by, for example, LEDs that emit white light. In this case, the light sources 11 may be constituted by, for example, a red light emitting element, a green light emitting element, and a blue light emitting element or by a blue light emitting element or an ultraviolet light emitting element and a phosphor.

The plurality of light sources 11 are arrayed at predetermined pitches in the B direction and are disposed symmetrically with respect to the center line Lb of the light guide plate 13 in the B direction. Herein, where, as shown in FIG. 3, disposition pitches of the light sources 11 are denoted as P1, P2, P3, P4, P5, P6, and P7 in order from a center portion toward each of end portions in the B direction (array direction), the disposition pitch P1 of the light sources 11 at the center portion in the B direction is smaller than the disposition pitch P7 of the light sources 11 at each of the end portions in the B direction. That is, a disposition density of the light sources 11 is higher at the center portion in the B direction than at the end portions in the B direction.

Furthermore, the disposition pitches of the light sources 11 become larger in a direction from the center portion toward each of the end portions in the B direction, satisfying P1≦P2≦P3≦P4≦P5≦P6≦P7 (where P1<P7). That is, the disposition density of the light sources 11 becomes higher in a direction from each of the end portions toward the center portion in the B direction. Preferably, the disposition pitches of the light sources 11 satisfy P1<P2<P3<P4<P5<P6<P7.

Furthermore, as shown in FIG. 2, the plurality of light sources 11 are mounted on the mounting substrate 12. The mounting substrate 12 is intended to supply the light sources 11 with power and may be so formed as to be capable of individually adjusting an intensity of light emitted from each of the light sources 11. In this case, local dimming control is enabled in which an intensity of light emitted from each of the light sources 11 is controlled synchronously with variations in brightness of a displayed image. This allows a displayed image to have a higher contrast and power consumption of the lighting device 10 to be reduced. In the following description, unless otherwise specified, it is assumed that each of the light sources 11 is supplied with power of an equal magnitude, and that a substantially equal amount of light is emitted from each of the light sources 11.

As shown in FIG. 1, the reflection sheet 14 has a function of reflecting light that has leaked from the rear surface of the light guide plate 13 to the side of the light guide plate 13. The optical sheet 15 is constituted by a plurality of types of sheets such as a diffusion plate, a prism sheet, and a lens sheet, and has a function of diffusing light from the light guide plate 13 and a function of collecting light from the light guide plate 13 at a predetermined viewing angle. The diffusion plate, the prism sheet, the lens sheet, and so on are provided as required and may be omitted. The backlight chassis 16 is formed of, for example, a metal plate.

In this embodiment, as described above, the disposition density of the light sources 11 is set to be higher at the center portion in the B direction (array direction) than at the end portions in the B direction. Thus, the brightness on a center portion of the light guide plate 13 in the B direction becomes higher than that on end portions of the light guide plate 13 in the B direction, so that the brightness of the display panel 2 becomes higher at a center portion thereof in the B direction than at end portions thereof in the B direction. Thus, even in a case where the number of the light sources 11 is reduced, the brightness of the display panel 2 at the center portion thereof can be secured. Furthermore, since the number of the light sources 11 can be reduced, weight and cost reductions of the lighting device 10 can be achieved.

Furthermore, as described above, the disposition density of the light sources 11 becomes higher in a direction from each of the end portions toward the center portion. This can make the brightness of the display panel 2 become gradually higher in a direction from each of the end portions thereof toward the center portion thereof and thus can suppress the occurrence of unevenness in brightness of the display panel 2.

Next, with reference to FIGS. 4 to 6, a description is given of an experiment performed to confirm the above-described effects.

In this confirmation experiment, with respect to each of Example 1 corresponding to the first embodiment and Comparative Example 1 in which disposition pitches of light sources 11 were set to be equal, a brightness distribution on a light guide plate 13 at predetermined positions was determined by simulation.

In Example 1, as shown in FIG. 4, 14 light sources 11 were arrayed along a side surface (light input surface) 13b. Furthermore, a configuration was adopted in which disposition pitches of the light sources 11 were set to become gradually larger in a direction from a center portion toward each of end portions in a B direction, satisfying P1<P2<P3<P4<P5<P6<P7. Other structures were similar to those in the foregoing first embodiment.

In Comparative Example 1, as shown in FIG. 5, 18 light sources 11 were arrayed along a side surface (light input surface) 13b. Furthermore, a configuration was adopted in which disposition pitches of the light sources 11 were all set to be equal, satisfying p1=p2=p3=p4=p5=p6=p7=p8=p9. Other structures were similar to those in Example 1.

Then, with respect to each of Example 1 and Comparative Example 1, a brightness distribution on the light guide plate 13 at positions (along a C1-C1 line in each of FIGS. 4 and 5) inward by a predetermined distance from the side surface (light input surface) 13b was determined FIG. 6 shows results thereof.

With reference to FIG. 6, it has been found that, in Example 1, despite the fact that the number of the light sources 11 is reduced compared with that in Comparative Example 1, the brightness at the center portion in the B direction becomes higher than that in Comparative Example 1. This has led to a finding that, when it is sufficient to obtain a brightness value at the center portion equal to that in the conventional case (Comparative Example 1), it is possible to further reduce the number of the light sources 11 and to reduce power to be supplied to the light sources 11. Furthermore, it has also been found that brightness distributions symmetrical in the B direction are obtained.

### Second Embodiment

In this second embodiment, with reference to FIGS. 7 to 10, a description is given of a case where, unlike the foregoing first embodiment, a plurality of light sources 11 are arrayed along two side surfaces 13b of a light guide plate 13.

In the second embodiment, as shown in FIG. 7, a plurality of light sources 11 are arrayed along, among four side surfaces 13b of a light guide plate 13, both of long-side side surfaces 13b (both long-side side surfaces). That is, the plurality of light sources 11 are arrayed along the side surface 13b on an A1 side (upper-side side surface) and the side surface 13b on an A2 side (side opposite to the A1 side) (lower-side side surface). Furthermore, the side surface 13b on the A1 side and the side surface 13b on the A2 side both act as light input surfaces.

Furthermore, the plurality of light sources 11 are disposed symmetrically with respect to a center line La of the light guide plate 13 in an A direction. Accordingly, the light sources 11 on the A2 side are disposed at disposition pitches equal to those at which the light sources 11 on the A1 side are disposed.

The plurality of light sources 11 are disposed symmetrically with respect to the center line La of the light guide plate 13 in the A direction and a center line Lb of the light guide plate 13 in a B direction, and accordingly, a processed portion at a rear surface of the light guide plate 13 also is formed symmetrically with respect to the center lines La and Lb.

In this configuration, brightness distributions on the light guide plate 13 at predetermined positions (along a C1-C1 line, a C2-C2 line, a C3-C3 line, and a C4-C4 line in FIG. 7) were determined in a similar manner to that in the foregoing first embodiment. FIGS. 8 and 9 show results thereof.

With reference to FIGS. 8 and 9, it has been found that, in each of both the A direction and the B direction, the brightness becomes higher at a center portion than at end portions. Furthermore, as shown in FIG. 8, it has also been found that the brightness distribution along the C1-C1 line and the brightness distribution along the C3-C3 line coincide with each other. That is, it has been found that brightness distributions symmetrical in the A direction are obtained. Conceivably, this is because the light sources 11 are disposed symmetrically with respect to the center line La of the light guide plate 13 in the A direction.

Next, a description is given of a case where a display device 1 is vertically disposed. Herein, the description assumes that the A1 side is the topside and the A2 side is the bottom side.

In a case where a display device 1 of this embodiment is used in a vertically disposed state, as shown in FIG. 10, the temperature of a lighting device 10 becomes higher on the topside thereof (A1 side) than on the bottom side thereof (A2 side). That is, the ambient temperature of the light sources 11 on the topside becomes higher than that of the light sources 11 on the bottom side. Conceivably, this is because air containing heat generated at the light sources 11 travels upward, so that the heat is accumulated on the topside of the lighting device 10.

When the light sources 11 undergoes a temperature increase during their use, light emission efficiency thereof is decreased. Because of this, in the case where the display device 1 is used in the vertically disposed state, the light emission efficiency of the light sources 11 on the bottom side becomes higher than that of the light sources 11 on the topside. For this reason, when the light sources 11 on the topside and the light sources 11 on the bottom side are supplied with power of an equal magnitude, the amount of light emitted from the plurality of light sources 11 on the bottom side becomes greater than that of light emitted from the plurality of light sources 11 on the topside. With this in view, power to be supplied to the light sources 11 on the bottom side is set to be smaller than power to be supplied to the light sources 11 on the topside, and thus the amount of light emitted from the plurality of light sources 11 on the bottom side can be made equal to that of light emitted from the plurality of light sources 11 on the topside, and the brightness distributions shown in FIGS. 8 and 9 can be obtained. In this case, since power to be supplied to the light sources 11 on the bottom side is reduced, power consumption can be reduced.

Other structures used in the second embodiment are similar to those in the foregoing first embodiment.

In this embodiment, as described above, the plurality of light sources 11 are disposed symmetrically with respect to the center line La of the light guide plate 13 in the A direction. This can improve uniformity of the brightness of a display panel 2 between at a portion thereof on the A1 side and at a portion thereof on the A2 side. Furthermore, in forming the processed portion at the rear surface of the light guide plate 13, it is only required that the processed portion be symmetrical with respect to the center line La, and thus designing and manufacturing of the processed portion can be facilitated.

Furthermore, as described above, in the case where the display device 1 is vertically disposed, power to be supplied to the light sources 11 on the bottom side is smaller than power to be supplied to the light sources 11 on the topside. On the bottom side of the light guide plate 13, compared with the topside thereof, it is less likely that heat is accumulated to cause a high temperature rise, and thus the light emission efficiency of the light sources 11 on the bottom side is unlikely to be decreased. With this in view, power to be supplied to the light sources 11 on the bottom side is set to be smaller than power to be supplied to the light sources 11 on the topside, and thus it is possible to improve uniformity of the brightness of the display panel 2 between at a portion thereof on the topside and at a portion thereof on the bottom side.

Other effects of the second embodiment are similar to those of the foregoing first embodiment.

### Third Embodiment

This third embodiment is described assuming a case where a display device 1 is vertically disposed but is applicable also to a case where the display device 1 is non-vertically disposed. In the third embodiment, as shown in FIG. 11, unlike the foregoing second embodiment, the number (for example, ten) of light sources 11 on an A2 side (bottom side) is smaller than the number (for example, 14) of light sources 11 on an A1 side (topside). Furthermore, disposition pitches of the light sources 11 on the A2 side become larger in a direction from a center portion toward each of end portions in a B direction, satisfying P11≦P12≦P13≦P14≦P15 (where P11<P15). That is, a disposition density of the light sources 11 on the A2 side becomes higher in a direction from each of the end portions toward the center portion in the B direction. Preferably, disposition pitches of the light sources 11 on the A2 side satisfy P11<P12<P13<P14<P15. Furthermore, the light sources 11 on the A2 side also are disposed symmetrically with respect to a center line Lb of a light guide plate 13 in the B direction.

Other structures used in the third embodiment are similar to those in the foregoing second embodiment.

In this embodiment, as described above, the plurality of light sources 11 are arrayed along both of side surfaces 13b of the light guide plate 13 on the A1 side and the A2 side. Thus, even when there is a difference in number between the light sources 11 on the A1 side and the light sources 11 on the A2 side, compared with a case where the light sources 11 are disposed only on the A1 side as in the foregoing first embodiment, it is possible to improve uniformity of the brightness of a display panel 2 between at a portion thereof on the A1 side and at a portion thereof on the A2 side.

Furthermore, as described in the foregoing second embodiment, in the case where the display device 1 is used in the vertically disposed state, when the light sources 11 on the topside (A1 side) and the light sources 11 on the bottom side (A2 side) are supplied with power of an equal magnitude, the amount of light emitted from the light sources 11 on the bottom side becomes greater than that of light emitted from the light sources 11 on the topside. With this in view, in the case where the display device 1 is used in the vertically disposed state, the number of the light sources 11 on the bottom side is set to be smaller than that of the light sources 11 on the topside, and thus it is possible to improve uniformity of the brightness of the display panel 2 between at a portion thereof on the topside and at a portion thereof on the bottom side.

Other effects of the third embodiment are similar to those of the foregoing first and second embodiments.

### Fourth Embodiment

Next, with reference to FIGS. 12 to 14, a description is given of a display device 1 according to a fourth embodiment. In this fourth embodiment, a case is described where, unlike the foregoing first to third embodiments, a plurality of light sources 11 are arrayed along one of short-side side surfaces (side surface on a B1 side) 13b of a light guide plate 13.

In the fourth embodiment, as shown in FIGS. 12 and 13, a plurality of light sources 11 are arrayed along, among four side surfaces 13b of a light guide plate 13, a side surface (side surface on a B1 side) 13b, which is one of short-side side surfaces 13b. In this embodiment, among the four side surfaces 13b, the side surface 13b on the B1 side acts as a light input surface. For the sake of easier explanation, one side of the light guide plate 13 in a longer length direction thereof is denoted as the B1 side.

As shown in FIG. 13, the plurality of light sources 11 are arrayed at predetermined pitches in an A direction and are disposed symmetrically with respect to a center line La of the light guide plate 13 in the A direction. Herein, where disposition pitches of the light sources 11 are denoted as P101, P102, P103, P104, and P105 in order from a center portion toward each of end portions in the A direction (array direction), the disposition pitch P101 of the light sources 11 at the center portion in the A direction is smaller than the disposition pitch P105 of the light sources 11 at each of the end portions in the A direction. That is, a disposition density of the light sources 11 is higher at the center portion in the A direction than at the end portions in the A direction.

Furthermore, the disposition pitches of the light sources 11 become larger in a direction from the center portion toward each of the end portions in the A direction, satisfying P101≦P102≦P103≦P104≦P105 (where P101<P105). That is, the disposition density of the light sources 11 becomes higher in a direction from each of the end portions toward the center portion in the A direction. Preferably, the disposition pitches of the light sources 11 satisfy P101<P102<P103<P104<P105.

Furthermore, as shown in FIG. 14, a display panel 2 is configured to operate from an A1 side to an A2 side. Furthermore, at light emission timing synchronous with the operation of the display panel 2, the plurality of light sources 11 emit light sequentially from the A1 side to the A2 side.

Other structures used in the fourth embodiment are similar to those in the foregoing first embodiment.

In this embodiment, as described above, the plurality of light sources 11 are arrayed along the side surface 13b of the light guide plate 13 on the B1 side. With this configuration, at light emission timing synchronous with the operation of the display panel 2, the plurality of light sources 11 can be made to emit light sequentially from the A1 side to the A2 side. In this case, it is possible to suppress an afterimage effect of the display panel 2 and to improve moving image display performance thereof. Furthermore, in a case where the light sources 11 are set not to emit light in an operation OFF region (region through which backlight light is not transmitted) of the display panel 2, power consumption of a lighting device 10 can be reduced.

Other effects of the fourth embodiment are similar to those of the foregoing first embodiment.

### Fifth Embodiment

In this fifth embodiment, with reference to FIGS. 15 to 17, a description is given of a case where, unlike the foregoing fourth embodiment, a plurality of light sources 11 are arrayed along two short-side side surfaces 13b of a light guide plate 13.

In the fifth embodiment, as shown in FIG. 15, a plurality of light sources 11 are arrayed along, among four side surfaces 13b of a light guide plate 13, both of short-side side surfaces 13b (both short-side side surfaces). That is, the plurality of light sources 11 are arrayed along the side surface 13b on a B1 side and the side surface 13b on a B2 side (side opposite to the B1 side). Furthermore, the side surface 13b on the B1 side and the side surface 13b on the B2 side both act as light input surfaces.

Furthermore, the plurality of light sources 11 are disposed symmetrically with respect to a center line Lb of the light guide plate 13 in a B direction. Accordingly, the light sources 11 on the B2 side are disposed at disposition pitches equal to those at which the light sources 11 on the B1 side are disposed.

The plurality of light sources 11 are disposed symmetrically with respect to a center line La of the light guide plate 13 in an A direction and the center line Lb of the light guide plate 13 in the B direction, and accordingly, a processed portion at a rear surface of the light guide plate 13 also is formed symmetrically with respect to the center lines La and Lb.

In this configuration, brightness distributions on the light guide plate 13 at predetermined positions (along a C101-C101 line, a C102-C102 line, a C103-C103 line, and a C104-C104 line in FIG. 15) were determined in a similar manner to that in the foregoing second embodiment. FIGS. 16 and 17 show results thereof.

With reference to FIGS. 16 and 17, it has been found that, in each of both the A direction and the B direction, the brightness becomes higher at a center portion than at end portions. Furthermore, as shown in FIG. 17, it has also been found that the brightness distribution along the C102-C102 line and the brightness distribution along the C104-C104 line coincide with each other. That is, it has been found that brightness distributions symmetrical in the B direction are obtained. Conceivably, this is because the light sources 11 are disposed symmetrically with respect to the center line Lb of the light guide plate 13 in the B direction.

Other structures used in the fifth embodiment are similar to those in the foregoing fourth embodiment.

In this embodiment, as described above, the plurality of light sources 11 are disposed symmetrically with respect to the center line Lb of the light guide plate 13 in the B direction. This can improve uniformity of the brightness of a display panel 2 between at a portion thereof on the B1 side and at a portion thereof on the B2 side. Furthermore, in forming the processed portion at the rear surface of the light guide plate 13, it is only required that the processed portion be symmetrical with respect to the center line Lb, and thus designing and manufacturing of the processed portion can be facilitated.

Other effects of the fifth embodiment are similar to those of the foregoing fourth embodiment.

### Sixth Embodiment

In this sixth embodiment, with reference to FIGS. 18 and 19, a description is given of a case where, unlike the foregoing first to fifth embodiments, power to be supplied to, among a plurality of light sources 11, each one at end portions in an array direction of the plurality of light sources 11 is larger than power to be supplied to, among the plurality of light sources 11, each one at a center portion in the array direction.

In the sixth embodiment, as shown in FIG. 18, power to be supplied to each one among light sources 11 at end portions in an array direction (A direction) is larger than power to be supplied to each one among the light sources 11 at a center portion in the array direction. Specifically, where power to be supplied to each of the light sources 11 is denoted as Q1, Q2, Q3, Q4, and Q5 in order from the center portion toward each of the end portions in the A direction (array direction), power to be supplied to each of the light sources 11 becomes larger in a direction from the center portion toward each of the end portions in the A direction, satisfying Q1≦Q2≦Q3≦Q4≦Q5 (where Q1<Q5). Furthermore, preferably, power to be supplied to each of the light sources 11 satisfies Q1<Q2<Q3<Q4<Q5. In FIG. 18, power to be supplied to each of the light sources 11 in an assumed case where all the light sources 11 are supplied with power of an equal magnitude is shown by triangle marks and a broken line.

In this configuration, a brightness distribution at predetermined positions (along the C103-C103 line in FIG. 15) was determined in a similar manner to that in the foregoing fifth embodiment. FIG. 19 shows a result thereof. In FIG. 19, a brightness distribution to be obtained in an assumed case where all the light sources 11 are supplied with power of an equal magnitude is shown by a broken line.

With reference to FIG. 19, it has been found that, compared with the case where all the light sources 11 are supplied with power of an equal magnitude, the brightness at the end portions in the A direction becomes higher, and that uniformity of the brightness is improved.

Other structures used in the sixth embodiment are similar to those in the foregoing fifth embodiment.

In this embodiment, as described above, power to be supplied to each one among the light sources 11 at the end portions in the array direction is set to be larger than power to be supplied to each one among the light sources 11 at the center portion in the array direction. This can prevent the brightness on end portions of a light guide plate 13 from becoming excessively lower than that on a center portion of the light guide plate 13 and thus can prevent the brightness of a display panel 2 from becoming excessively lower at end portions thereof than at a center portion thereof. Thus, uniformity of the brightness of the display panel 2 can be further improved.

Other effects of the sixth embodiment are similar to those of the foregoing fifth embodiment.

The embodiments and examples disclosed here are to be construed in all respects to be illustrative and not limiting. The scope of the present invention is indicated by the appended claims rather than by the foregoing descriptions of the embodiments and examples, and all changes that come within the meaning and range of equivalency of the claims are intended to be embraced therein.

For example, while the foregoing embodiments exemplarily describe a case where a liquid crystal display panel is used as a display panel, the present invention is not limited thereto and may be applied to a display panel other than a liquid crystal display panel.

Furthermore, while the foregoing embodiments describe, as one example of a lighting device, a backlight device that illuminates a display panel, the present invention is not limited thereto and is applicable also to a lighting device that illuminates a member to be illuminated other than a display panel.

Furthermore, while the foregoing embodiments exemplarily describe a case where light sources are arrayed along one or two of four side surfaces of a light guide plate, the present invention is not limited thereto. A configuration also may be adopted in which light sources are arrayed along three or four of four side surfaces of a light guide plate.

Furthermore, while, for example, the foregoing second embodiment exemplarily describes a case where light sources are arrayed along two long-side side surfaces of a light guide plate such that the light sources on an A1 side are symmetrical to the light sources on an A2 side, the present invention is not limited thereto. It is not required that the light sources on the A1 side and the light sources on the A2 side be disposed symmetrically to each other. For example, a configuration may be adopted in which light sources on an A1 side and light sources on an A2 side are set to be equal in number and different only in their disposition pitches. The same applies to a case where light sources are arrayed along two short-side side surfaces of a light guide plate.

Furthermore, while the foregoing sixth embodiment exemplarily describes a case where, in a configuration similar to that of the foregoing fifth embodiment, power to be supplied to each one among light sources at end portions is set to be larger than power to be supplied to each one among the light sources at a center portion, the present invention is not limited thereto. Also in each of the configurations of the foregoing first to fourth embodiments, power to be supplied to each one among the light sources at the end portions may be set to be larger than power to be supplied to each one among the light sources at the center portion.

### LIST OF REFERENCE SYMBOLS

1 display device

2 display panel (member to be illuminated)

10 lighting device

11 light source

13 light guide plate

13b side surface

La, Lb center line

Q1 to Q5 power

1-12. (canceled)

13. A lighting device that is disposed on a rear surface side of a member to be illuminated, comprising:
a plurality of light sources; and
a light guide plate that light from the light sources enters and that guides light from the light sources,
wherein
the plurality of light sources are arrayed along at least one side surface of the light guide plate, and
a disposition density of the light sources becomes higher in a direction from each of end portions toward a center portion in an array direction of the plurality of light sources.

14. The lighting device according to claim 13, wherein
the plurality of light sources are arrayed along at least one short-side side surface of the light guide plate.

15. The lighting device according to claim 14, wherein
the plurality of light sources are arrayed along both short-side side surfaces of the light guide plate.

16. The lighting device according to claim 15, wherein
the plurality of light sources are disposed symmetrically with respect to a center line of the light guide plate in a longer length direction thereof.

17. The lighting device according to claim 13, wherein
the plurality of light sources are arrayed along at least one long-side side surface of the light guide plate.

18. The lighting device according to claim 17, wherein
the plurality of light sources are arrayed along both long-side side surfaces of the light guide plate.

19. The lighting device according to claim 18, wherein
the plurality of light sources are disposed symmetrically with respect to a center line of the light guide plate in a shorter length direction thereof.

20. The lighting device according to claim 13, wherein
power to be supplied to each one among the light sources at the end portions is larger than power to be supplied to each one among the light sources at the center portion.

21. The lighting device according to claim 13, wherein
the plurality of light sources are arrayed along an upper-side side surface and a lower-side side surface of the light guide plate, and
a number of those of the light sources that are arrayed along the lower-side side surface is smaller than a number of those of the light sources that are arrayed along the upper-side side surface.

22. The lighting device according to claim 13, wherein
the plurality of light sources are arrayed along an upper-side side surface and a lower-side side surface of the light guide plate, and
power to be supplied to each of those of the light sources that are arrayed along the lower-side side surface is smaller than power to be supplied to each of those of the light sources that are arrayed along the upper-side side surface.

23. A display device, comprising:
the lighting device according to claim 13, and
a display panel that is illuminated by the lighting device.
